(19) United States
(12) Patent Application Publication
(10) Pub. No.: US 2009/0128943 A1
(43) Pub. Date: May 21, 2009

(54) Test method and manufaturing method of disk drive device in consideration of manufacturing efficiency

(76) Inventors: Kazuyuki Ishibashi, Kanagawa (JP); Kazunari Tsuchimoto, Kanagawa (JP); Takahiro Saito, Kanagawa (JP); Osamu Takazawa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/290,321

(22) Filed: Oct. 28, 2008

(30) Foreign Application Priority Data
Nov. 20, 2007 (JP) 2007-301043

(51) Int. Cl. G11B 27/36

(52) U.S. Cl. 360/31; G9B/27.052

(57) ABSTRACT

Embodiments of the present invention help to improve test processes for hard disk drives (HDDs) and increase the manufacturing efficiency of HDDs. According to one embodiment, a test process performs a test on an HDD with respect to a plurality of items and stores one or a plurality of test results. Moreover, it determines the optimum specification category to which the HDD is to belong based on the stored test results. One factor of the specifications—storage capacity—has been determined before the test process or is determined during the test process. The test process classifies HDDs with the same storage capacity into different specification categories, and this classification may be performed in a single test process. This achieves efficient manufacture of HDDs with different specifications corresponding to the diversified usage of HDDs.

### CROSS-REFERENCE TO RELATED APPLICATION

The instant nonprovisional patent application claims priority to Japanese Patent Application No. 2007-301043 filed Nov. 20, 2007 and which is incorporated by reference in its entirety herein for all purposes.

### BACKGROUND OF THE INVENTION

Disk drive devices using various kinds of recording disks, such as optical disks, magneto-optical disks, flexible magnetic disks, and the like, have been known in the art. In particular, hard disk drives (HDDs) have been widely used as storage devices of computers and have been one of indispensable storage devices for current computer systems. Moreover, HDDs have found widespread application to moving image recording/reproducing apparatuses, car navigation systems, cellular phones, and the like, in addition to the computers, due to their outstanding characteristics.

A magnetic disk used in an HDD has multiple concentric data tracks and servo tracks. Each data track includes multiple data sectors containing user data recorded thereon. Each servo track includes address information. Servo tracks are constituted by multiple servo data arranged discretely in the circumferential direction and one or more data sectors are recorded between the servo data. A head slider fixed to a pivoting actuator accesses a desired data sector in accordance with address information in servo data. In this way, the HDD writes data to and retrieves data from a data sector.

In recent years, storage capacity and operation performance of HDDs have remarkably progressed. As recording density of a magnetic disk and operation speed of an HDD increase, criteria required for individual portions of the HDD is becoming severer. An HDD comprises a number of components, and manufacturing uniformity in components such as head sliders, actuators, or magnetic disks cannot be expected in manufacturing those components. As a result, in a test process in manufacturing HDDs, a number of HDDs may not be able to pass the test and may be transferred to a retest process or a rework process. A typical test process takes several days so that retests of HDDs significantly decrease the throughput in manufacturing HDDs.

In a rework process, HDDs are disassembled and a part of the components are discarded. A typical HDD comprises a plurality of head sliders. It is often difficult to disassemble a head gimbal assembly (HGA), which is an assembly of an actuator and head sliders. Therefore, even if any one of the head sliders does not pass the criteria, the HGA including other parts than the head slider is to be discarded. To overcome such a problem, a Japanese Patent Publication No. 10-106179 (“Patent Document 1”) has proposed a technique that selects the capacity in accordance with characteristics of each HDD (HGA) to reduce the number of discarded HGAs while keeping the reliability of the HDD.

One typical criteria for the reliability of HDDs is the error rate. An HDD has an error correction function and can use ECCs to correct errors at no more than a specific error rate. An HDD with a higher error rate is regarded as a less reliable HDD. Therefore, an HDD which does not satisfy a predetermined error rate in a test process is determined to be a failed product. The technique in the Patent Document 1 measures the error rate at a write frequency in accordance with the specified storage capacity of the HDD, and if the error rate does not satisfy the criteria, it lowers the specified capacity (write frequency) of the HDD.

Generally, as the write frequency becomes lower, the error rate decreases. Accordingly, if the head performance is poor, selecting a lower write frequency or a smaller storage capacity to meet the performance allows manufacturing an HDD satisfying the criteria for the error rate. In this way, selecting a storage capacity in accordance with the head characteristics increases manufacturing yields of HDDs.

Diversification of use and usage of HDDs leads to diversification of request to HDDs. There exist various uses (usages) for HDDs, such as use where continuous use for a long time is expected, use where shorter response time is requested, and use where accesses in special conditions are premised like an HDD to be mounted in AV equipment. The specification (requested specification) such as requested performance and reliability changes in accordance with these various uses. Therefore, it is important to manufacture HDDs effectively to meet the different specifications even if the HDDs have the same storage capacity.

Whether or not an HDD satisfies a given requested specification is ascertained in a test process in manufacturing the HDD. If there exist a plurality of different specification categories as described above, test processes corresponding to the respective specification categories may be performed. For this purpose, however, test equipment must be prepared for each specification category.

Focusing attention on the test process for each specification category, the same problem as in the previous test processes will occur in the severer test process. That is, an HDD determined to be failed product in the test process is transferred to a retest process or a rework process so that the manufacturing efficiency such as throughput or yield is significantly reduced. Accordingly, a test method which can efficiently manufacture HDDs corresponding to a plurality of different specification categories has been demanded.

### BRIEF SUMMARY OF THE INVENTION

Embodiments of the present invention help to improve test processes for HDDs and increase the manufacturing efficiency of HDDs. According to one embodiment, a test process performs a test on an HDD with respect to a plurality of items and stores one or a plurality of test results. Moreover, it determines the optimum specification category to which the HDD is to belong based on the stored test results. One factor of the specifications—storage capacity—has been determined before the test process or is determined during the test process. The test process classifies HDDs with the same storage capacity into different specification categories, and this classification may be performed in a single test process. This achieves efficient manufacture of HDDs with different specifications corresponding to the diversified usage of HDDs.

### BRIEF DESCRIPTION OF THE DRAWINGS

FIG. 1 is a block diagram schematically depicting the entire configuration of a hard disk drive according to one embodiment.

FIGS. 2(a) and 2(b) are diagrams schematically illustrating the data format on a recording surface in one embodiment.

FIG. 3 is a flowchart of a test process according to one embodiment.

FIGS. 4(a) and 4(b) are drawings schematically illustrating an ATI test, one of the test items for determining the specification category for an HDD, in one embodiment.

FIGS. 5(a)-5(c) are drawings schematically illustrating a squeeze test, one of the test items for determining the specification category for an HDD, in one embodiment.

FIG. 6 is a drawing schematically illustrating a data track width measurement test, one of the test items for determining the specification category for an HDD, in one embodiment.

FIG. 7 is a flowchart of a test process according to an aspect of one embodiment.

### DETAILED DESCRIPTION OF THE INVENTION

Embodiments of the present invention relate to a test method and a manufacturing method of a disk drive device in consideration of manufacturing efficiency, more particularly, to a test method and a manufacturing method suitable for different types of disk drive devices.

An aspect of embodiments of the preset invention is a test method of a disk drive device. This method positions a head using servo data on a disk. It conducts tests with respect to a plurality of items by writing and/or retrieving data to/from the disk using the positioned head. It determines a specification category to which the disk drive device with a predetermined storage capacity is to belong based on the test results on one or more items selected from the plurality of items. Determining the specification category to which the disk drive device with a predetermined storage capacity is to belong accomplishes efficient manufacture of a disk drive device.

In one example, test results of at least a part of the test items to be used in determination of the specification category are pass or fail. This accomplishes efficient determination of the specification category. Or, the servo data may be written on the disk using the head and to select the storage capacity from preset values in accordance with head characteristics after writing the servo data. This accomplishes efficient manufacture of a disk drive device.

In one example, a test item to be used in determination of the specification category measures variation in error rate on a center track caused by writing the both adjacent data tracks. Moreover, a test item to be used in determination of the specification category measures variation in error rate when target positions of both adjacent data tracks are brought closer to a center data track than in a normal operation. This accomplishes proper determination of specification category.

In one example, a test item to be used in determination of the specification category measures a response time to a command from an external. This accomplishes proper determination of specification category.

The specification category subjected to the determination may be selected from a plurality of specification categories in accordance with setting. Also, the storage capacity subjected to the selection may be selected from a plurality of specification categories in accordance with setting. These accomplish control of the quantity to be manufactured for each specification category.

A manufacturing method of a disk drive device according to another aspect of embodiments of the present invention positions a head using servo data on a disk. It conducts tests on the disk drive device by writing and/or retrieving data to/from the disk using the positioned head. It selects one or more specification categories subjected to determination from a plurality of specification categories in accordance with setting. It determines a specification category to which the disk drive device is to belong based on the test results. Selecting one or more specification categories subjected to determination from a plurality of specification categories in accordance with setting accomplishes effective control of the quantity to be manufactured for each specification category.

Selecting one or more specification categories subjected for determination from a plurality of specification categories may include selecting a storage capacity of the disk drive device. The test on the disk drive device may include a plurality of test items on the disk drive device of which the storage capacity has been predetermined, the final specification category to which the disk drive device with the predetermined storage capacity is to belong based on test results of the one or more items selected from the plurality of test items, and the specification category to be subjected to the determination of the final specification category may be selected from a plurality of specification categories in accordance with setting. This accomplishes efficient manufacture of disk drive devices and control of the quantity to be manufactured of disk drive devices in accordance with demand in the market.

Embodiments of the present invention can improve a test process of a disk drive device to increase the manufacturing efficiency.

Hereinafter, particular embodiments of the present invention will be described. For clarity of explanation, the following descriptions and accompanying drawings may have omissions and simplifications as appropriate. Throughout the drawings, like components are denoted by like reference numerals and repetitive descriptions are omitted as not necessary for the sake of clarity of explanation. In the embodiments, a hard disk drive (HDD) will be described as an example of a disk drive device.

A feature of embodiments is a test process in manufacturing an HDD. The test process of the embodiments conducts a test on the HDD with respect to a plurality of items and stores test results with respect to one or more of them. In addition, it determines the optimum specification category to which the HDD is to belong based on the stored test results. The storage capacity, one of the specifications, has been determined before the test process or is determined during the test process. An important feature in the test process of the embodiments is to further classify HDDs with the same storage capacity into different specification categories. Besides, the classification into appropriate specification categories is performed in a single test process. HDDs with different specifications corresponding to diversified usage of the HDDs can be manufactured efficiently.

Another feature of the embodiments is that the test process of the present embodiment has a switching function to select the specification category for classification. The switching function increases or decreases the number of specification categories into which the HDDs are to be classified through the test process. This accomplishes control of the quantity of HDDs to be manufactured which belong to each specification category in accordance with request in the market.

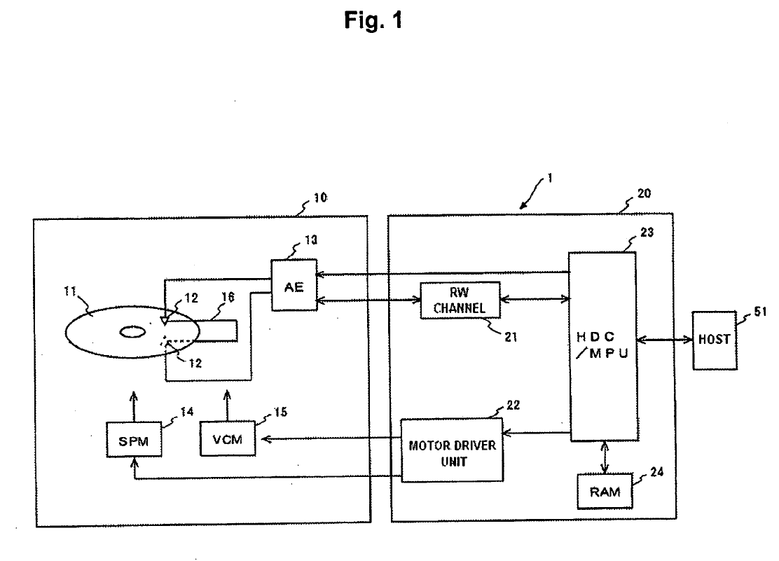

The test process for an HDD according to one embodiment is conducted by a control circuit mounted in the HDD. Before describing the test process of the present embodiment, an entire configuration of an HDD will be outlined referring to a block diagram of FIG. 1. An HDD 1 comprises a circuit board 20 fixed outside an enclosure 10. On the circuit board 20, circuits such as a read-write channel (RW channel) 21, a motor driver unit 22, an integrated circuit (HDC/MPU) 23 of a hard disk controller (HDC) and an MPU, and a semiconductor memory RAM 24 are mounted. In the enclosure 10, a spindle motor (SPM) 14 rotates a magnetic disk 11 at a specific angular rate. The magnetic disk 11 is a disk for storing data. In accordance with control data from the HDC/MPU 23, the motor driver unit 22 drives the SPM 14.

Head sliders 12 each comprise a slider flying over the magnetic disk and a head element portion fixed to the slider for converting magnetic signals into/from electric signals. A head slider 12 is an example of a head. An arm electronics (AE) 13 selects a head slider 12 to access (read or write) the magnetic disk 11 from multiple head sliders 12 in accordance with control data from the HDC/MPU 23 and amplifies read/write signals. Head sliders 12 are fixed to the tip end of an actuator 16. The actuator 16, which is coupled to a voice coil motor (VCM) 15, pivots about a pivotal shaft to move the head sliders 12 above the rotating magnetic disk 11 in its radial direction. The assembly of the actuator 16 and the VCM is the moving mechanism of the head. The motor driver unit 22 drives the VCM 15 in accordance with control data from the HDC/MPU 23.

The RW channel 21, in a read operation, extracts servo data and user data from read signals obtained from the AE 13 to decode them. The decoded data are supplied to the HDC/MPU 23. In a write operation, the RW channel 21 code-modulates write data supplied from the HDC/MPU 23 and converts the code-modulated data into write signals to supply them to the AE 13. In the HDC/MPU 23, the HDC is a logic circuit and the MPU operates in accordance with firmware loaded in the RAM 24. The HDC/MPU 23 is an example of a controller and performs entire control of the HDD 1 in addition to processes necessary for data processing such as head positioning control, interface control, defect management, and the like. In manufacturing the HDD 1, the HDC/MPU 23 conducts a test process for the HDD 1 in accordance with a test program downloaded from a test computer (not shown).

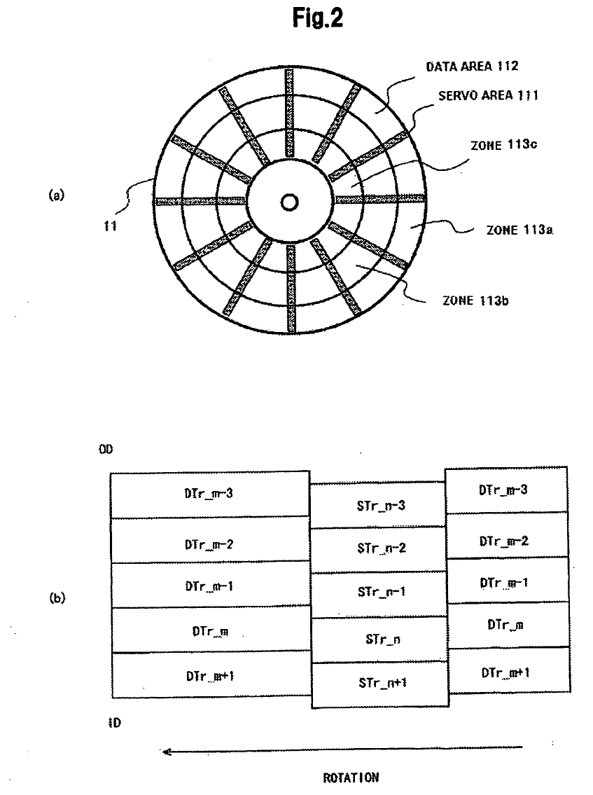

FIG. 2(a) schematically depicts a data structure of an entire recording surface of the magnetic disk 11, and FIG. 2(b) schematically depicts a data format of a part of the recording surface. On the recording surface of the magnetic disk 11, multiple servo areas 111 extending radially in the radial direction from the center of the magnetic disk 11 and being located discretely at every specific angle, and data areas 112 each formed between two adjacent servo areas 111 are provided. In each servo area 111, servo data for performing positional control of a head slider 12 are recorded. In each data area 112, user data are recorded.

On the recording surface of the magnetic disk 11, multiple data tracks (DTr) having a specific width in the radial direction are formed concentrically. The user data are recorded along data tracks. A data track includes a data sector as a record unit of user data and is typically constituted by multiple data sectors. Typically, a plurality of data tracks are grouped into a plurality of zones 113a to 113c according to their radial positions of the magnetic disk 11. The number of data sectors included in a data track is set to each of the zones.

Similarly, the magnetic disk 11 includes multiple concentric servo tracks (STr) having a specific width in the radial direction. Each servo track is constituted by multiple servo data split by a data area 112. Servo data include a servo track number, a servo sector number in the servo track, and burst patterns for fine positional control. The burst patterns are constituted by, for example, four burst patterns A, B, C, and D different in the radial position. The amplitudes of reproducing signals of each burst pattern can determine the position in the servo track. The position in the servo track can be expressed by a so-called position error signal (PES) value. The PES value is calculated from the amplitudes of the burst patterns A, B, C, and D; and for example, one servo track is divided into 256 PES values in the radial direction.

As illustrated in FIG. 2(b), the servo track pitch does not conform to the data track pitch on the same recording surface in the present embodiment. The data track pitches are individually set depending on the characteristics of the head slider 12. Specifying the data track pitch for each head slider 12 leads to the optimum data track pitch corresponding to the characteristics of the head slider 12, which achieves reduction in the adjacent track interference in data write and increases in the storage capacity (the number of data tracks).

A manufacturing method of an HDD 1 manufactures an assembly of head sliders 12 and an actuator 16, and mounts an AE 13 thereon. Further, it mounts this assembly, an SPM 14, magnetic disks 11, and a VCM 15 in an enclosure 10 to manufacture a head disk assembly (HDA). Then the HDA is transferred to a servo write step and servo tracks are written with head sliders 12 each corresponding to each recording surface of magnetic disks 11. This servo write may be performed by a method using a servo track writer (STW) as an external device or a method to write servo data with controlling the VCM 15 in the HDD 1 (self-servo-write). The servo write is a well known technique and detailed descriptions thereon are omitted in the present specification.

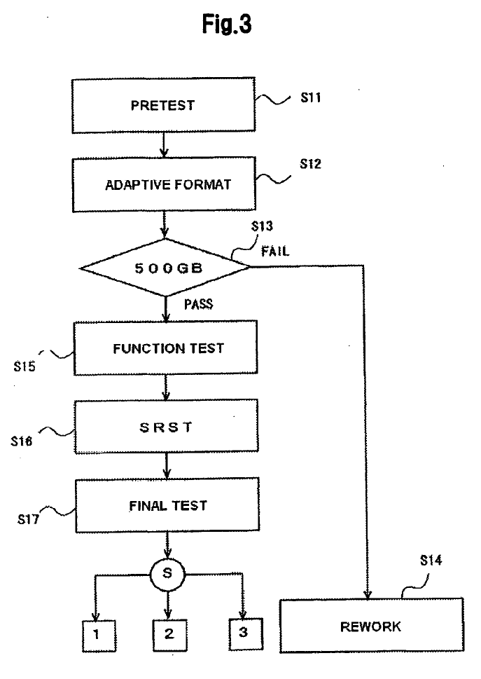

After the servo write, the control circuit board 20 is mounted on the HDA and the HDD 1 enters a test process. FIG. 3 is a flowchart illustrating an entire flow of the test process according to one embodiment. The HDC/MPU 23 starts the test process in accordance with a test program downloaded from a test computer of a host. The test process has many test items.

A conventional test process determines that an HDD 1 is a failed product if the HDD 1 does not pass any one of the test items. The test process of the embodiments does not stop the process for the preliminarily selected test items and continues the test process to the end even if the HDD 1 does not pass one of the preliminarily selected test items. After all the test items have been finished, the test process of the present embodiment determines the specification category to which the HDD 1 is to belong, referring to the test results on the preliminarily selected test items. If the HDD 1 does not pass a test item other than the test items for determination of specification category, the test process determines the HDD 1 to be a failed product.

Now referring to a flowchart of FIG. 3, the test process of one embodiment will be described. First, the HDC/MPU 23 performs a pretest (S11). The pretest is a test for setting optimum servo parameters for servo control and optimum channel parameters for the RW channel 21. After the pretest (S11), the HDC/MPU 23 determines the data track format of the magnetic disk 11 (S13). As explained in reference to FIG. 2(b), the HDD 1 according to the present embodiment employs an adaptive format to determine a track per inch (TPI) and a bit per inch (BPI) for every head slider 12 in accordance with characteristics of the head slider 12. A recording density is defined by the TPI and the BPI. The BPI is defined by recording frequencies. Typically, the TPI varies consecutively depending on the radial position, and the BPI is set to each of the zones 113a to 113c.

In the example of FIG. 3, the storage capacity of the HDD 1 is preliminarily specified as 500 GB. The TPIs and BPIs for head sliders 12 determined by the HDC/MPU 23 may not sometimes satisfy the storage capacity. In the flow in FIG. 3, if the adjusted TPIs and BPIs cannot satisfy the specified storage capacity (FAIL in S13), the HDD 1 is determined to be a failure to be transferred to a rework process or a retest process (S14). The retest process is identical to or different from the test process which has determined the HDD 1 to be a failure.

If a data track format satisfying the storage capacity of 500 GB (PASS in S13) has been set, the HDC/MPU 23 performs a function test (S15). In the function test, the HDC/MPU 23 conducts tests on several data tracks selected on the recording surface with respect to a number of items. In the present example, the following test items are selected as the test items for determination of specification categories from the test items.

The test items are an adjacent track interference (ATI) test, a squeeze test, and a data track width measurement test. These are the preferable test items for measuring error rate variation of a subject data track to determine a specification category by writing data on data tracks adjacent to the subject data track. The HDC/MPU 23 performs these tests on each head slider 12. Tests with respect to specific items among these may be skipped in the function test. For example, the ATI test and the squeeze test may be skipped in the function test.

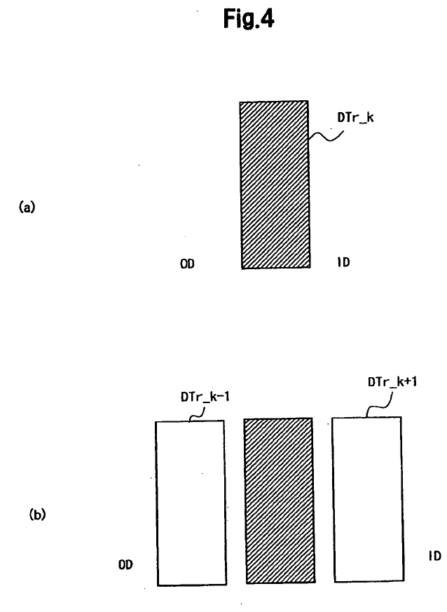

As shown in FIG. 4(a), the ATI test writes data on the center data track Dtr_k. Then as shown in FIG. 4(b), it repeats overwriting data on the both adjacent data tracks Dtr_k+1 and Dtr_k−1. The number of overwriting on the adjacent data tracks exceeds several thousands. After the predetermined number of overwriting on the adjacent data tracks, the HDC/MPU 23 reads the center data track to measure the error rate.

The HDC/MPU 23 has an error correction function which measures the error rate. The target position on the central data track Dtr_k in measuring the error rate is the track center of the data track. The HDC/MPU 23 stores the measured error rate in the RAM 24 or a flag indicating whether or not the measured error rate is within a reference error rate range (pass/fail flag) in the RAM 24. For example, the HDC/MPU 23 sets the maximum correctable error rate of the error correction function to the reference error rate; and if the center data track Dtr_k cannot be read, it determines that the measured error rate exceeds the reference error rate (fail).

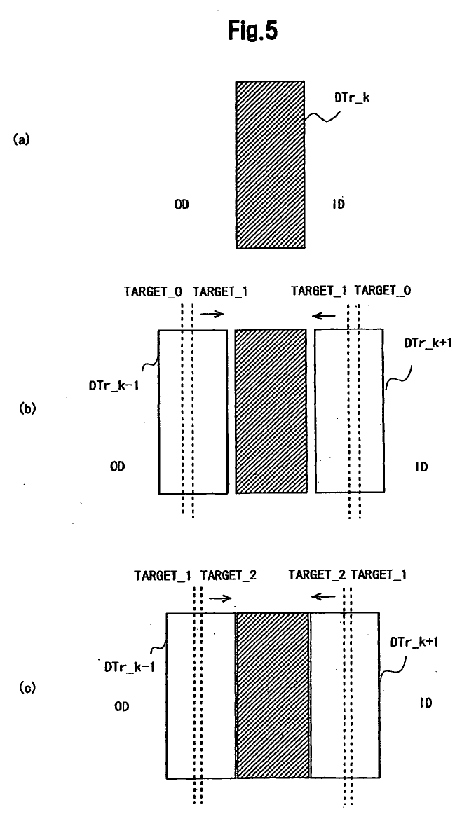

The squeeze test writes the both adjacent data tracks at closer (squeezed) positions to the center data track than usual. Then, it reads the center data track to measure the error rate. Specifically, as shown in FIG. 5(a), the HDC/MPU 23 writes data on the central data track Dtr_k. Next, as shown in FIG. 5(b), it writes the both adjacent data tracks Dtr_k+1 and Dtr_k−1 at target positions TARGET_1 which are closer to the center data track Dtr_k than the target position TARGET_0 in normal data write. The HDC/MPU 23 reads the center data track Dtr_k to measure the error rate. The target position on the center data track Dtr_k in measuring the error rate is the track center of the data track.

Then, the HDC/MPU 23 brings the adjacent data tracks Dtr_k+1 and Dtr_k−1 still closer to the center data track Dtr_k. Specifically, as shown in FIG. 5(c), the HDC/MPU 23 writes the both adjacent data tracks Dtr_k+1 and Dtr_k−1 at the target positions TARGET_2 which are still closer to the center data track Dtr_k than the target positions TARGET_1. The HDC/MPU 23 reads the center data track Dtr_k to measure the error rate.

In this way, the HDC/MPU 23 gradually brings the target positions of the adjacent data tracks Dtr_k+1 and Dtr_k−1 closer to the center data track Dtr_k and writes the adjacent data tracks Dtr_k+1 and Dtr_k−1 at different target positions to measure the error rates of center data track Dtr_k. The HDC/MPU 23 stores the measured values in measuring error rates in the RAM 24 or flags indicating whether or not the measured error rates are within a reference error rate range (pass/fail flag) in the RAM 24. This is the same as the above-described ATI test. In accordance with design, the reference error rate is set to different values depending on the target position of the adjacent data track or to the same value regardless of the target position.

In a data write, a write inhibit value has been set. The write inhibit value is expressed in PES. If the difference between the current position of a head slider 12 and the target position exceeds the write inhibit value, the HDC/MPU 23 stops the data write. In a squeeze test, as the target positions of the adjacent data tracks Dtr_k+1 and Dtr_k−1 come close to the center data track Dtr_k, the HDC/MPU 23 sets smaller write inhibit values. Especially, the target position and the write inhibit value are determined so that the position from the target positions of the adjacent data tracks Dtr_k+1 and Dtr_k−1 toward the center data track Dtr_k by the write inhibit value will be constant.

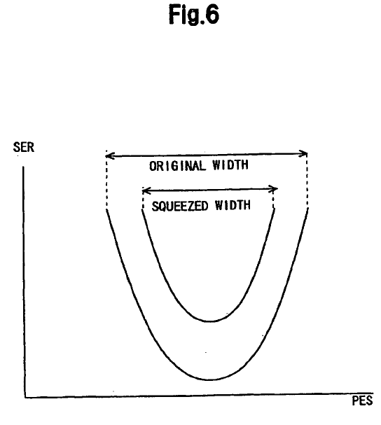

The data track width measurement test is a test to measure squeezed margins similarly to the squeeze test. A data track width is a width of a data track where an error rate in the data track is within a reference range. FIG. 6 exemplifies the relationship between the error rate and the radial position (PES) of the center data track Dtr_k. The ORIGINAL WIDTH is the data track width when the adjacent data tracks Dtr_k+1 and Dtr_k−1 are written at the normal target positions. The SQUEEZED WIDTH is the data track width when the adjacent data tracks Dtr_k+1 and Dtr_k−1 are written at the target positions closer to the center data track Dtr_k (squeezed write). The width can be expressed in PES. The squeezed write results in a narrower data track width.

After writing data on the adjacent data tracks Dtr_k+1 and Dtr_k−1, the HDC/MPU 23 measures the data track width of the center data track Dtr_k. Specifically, the HDC/MPU 23 retrieves data from the data track center and repeats the retrieval with shifting the target position bit by bit. Then, the HDC/MPU 23 measures an error rate at each position. The width where the error rates are within the reference range are the data track width. For example, the width with the error rate of 10-4 or less is the data track width.

The HDC/MPU 23 gradually brings the target positions of the adjacent data tracks Dtr_k+1 and Dtr_k−1 closer to the center data track Dtr_k and writes the adjacent data tracks Dtr_k+1 and Dtr_k−1 at different target positions to measure the error rates and the data track widths of the center data track Dtr_k. The HDC/MPU 23 stores the measured values in measuring data track widths in the RAM 24 or flags indicating whether or not the measured data track widths are within a reference range (pass/fail flag) in the RAM 24. In accordance with design, different values are set for the reference value depending on the target position of the adjacent data track or the same value regardless of the target position. Adjustment of the write inhibit value in the data track width measurement test is the same as in the squeeze test.

The HDC/MPU 23 conducts tests with respect to many items other than the above-described test items in the function test (S15). The HDC/MPU 23 conducts a function test on every head slider 12. As described above, the HDC/MPU 23 conducts a function test on a selected part of the data tracks. In contrast, the HDC/MPU 23 conducts tests on whole surface of a recording surface in the self run self test (SRST, S16) shown in the flowchart of FIG. 3.

The SRST (S16) performs a defect inspection test by scanning the whole surface of a recording surface. The defect inspection test writes data on each data track at a normal target position and then retrieves the written data. The HDC/MPU 23 repeats data write and data retrieval with changing the order of data track write or read to detect defect sectors on the recording surface. The HDC/MPU 23 registers the detected defect sectors in a defect table and skips them in a normal operation.

The SRST (S16) includes many test items other than the defect inspection test and the test items for determination of the specification category are selected from them. In the present example, the ATI test, the squeeze test, and the data track width measurement test are used for determination of the specification category as well as in the function test (S15). The test method on each test item is the same as the one in the function test (S15). The difference between the SRST and the function test is that the HDC/MPU 23 ascertains the data track with high probability of error occurrence by the defect inspection test and performs the above described tests on the ascertained data tracks. The tests are conducted under severer conditions comparing to the tests on arbitrarily chosen data tracks, which improves the reliability of the HDD 1.

As shown in FIG. 3, the HDC/MPU 23 conducts a final test (S17) after the SRST (S16). The HDC/MPU 23 uses only normal commands in the final test (S17). The HDC/MPU 23 performs read and write tests on the whole surface of a recording surface under the same conditions as the use environment for users. Specifically, the final test conducts tests with respect to the test items such as a seek speed measurement test, a throughput measurement test, an error rate measurement test, and the like.

In the final test (S17) of the present example, the throughput measurement test is selected as a test item for determination of the specification category. The throughput measurement test is a test for an entire HDD 1. For example, the throughput measurement test reads a given number of data sectors from given inner data tracks and outer data tracks to measure the response time in the operation. The HDC/MPU 23 stores the measured response times in the RAM 24, or stores flags whether or not the measured response time is within a reference time (pass/fail flag) in the RAM 24.

The HDC/MPU 23 or a test computer determines the specification category to which the HDD 1 is to belong in the final test (S17). In the example in FIG. 3, the HDC/MPU 23 assigns one of three specification categories 1 to 3 to the HDD 1. The method for determining the specification category depends on the design, and for example, the HDC/MPU 23 determines the specification category based on the results of pass/fail in the test items. Such simple determination criteria accomplish efficient determination of specification category.

Each specification category includes one or more test items in which the HDD 1 is required to pass among the test items for determination of specification category. For example, the specification category 1 requires the HDD 1 to pass all of the test items. The specification category 2 requires the HDD 1 to pass the ATI test, the squeeze test, and the data track width measurement test in the function test (S15) and the SRST (S16). Typically, all the head sliders 12 in the HDD 1 are required to pass these tests. The specification category 3 requires the HDD 1 to pass the throughput measurement test. HDDs 1 which do not satisfy requirements of any of the specification categories are determined to be failed products.

If test results on the items for determination of specification category are expressed by numerical values such as error rates or data track widths, the specification category can be determined in reference to the values. For example, the values of the test results are classified into several levels. The specification category 1 requires that the all test results belong to level 1. The specification category 2 requires that a part of the test results belong to the level 1 and the other test results belong to level 2 or level 1. The specification category 3 requires that a part of the test results belong to level 1 and the other test results belong to level 3, 2, or 1. On this occasion, when the HDC/MPU 23 stores the test results in the RAM 24, it may store the levels to which the measured values belong, instead of the measured values.

The test process in the present example comprises a switching function (S in FIG. 3) for selecting specification categories for classifying HDDs 1. Assume that the switching function selects the specification categories 1 and 2. Then, at the end of the test process, HDDs 1 are classified into the specification category 1 or 2, or failed products; and the specification category 3 will never be assigned to HDDs 1. If the switching function selects only the specification category 2, HDDs 1 are classified into the specification category 2 or failed products. The switching function is implemented in a device for determining the specification category at the end of the test process. Specifically, it is implemented into a test program of the HDC/MPU 23 or a program in the test computer.

The switching function controls the quantity to be manufactured of HDDs 1 belonging to each specification category. When there is no market demand for a specific specification category, manufacturing HDDs 1 of the specification category leads to unnecessary stock. Therefore, the switching function does not select the specification category which is not necessary to be manufactured (turns off the switch of the specification category) and selects the other specification categories only (turns on the switches of the specification categories). In this way, the switching function accomplishes control of the quantity to be manufactured to meet the demand.

Or, as understood from the above explanation, a certain specification category may be a high order of the other specification categories (the specification category 1 in the above example), or HDDs 1 included in each specification category may not be the same (the specification categories 2 and 3 in the above example). Since the HDDs 1 in the high order specification category satisfy the specifications in the other specification categories, the quantity to be manufactured may be large. However, between two specification categories having no inclusive relationship, it is necessary to determine which specification category is to be assigned to an HDD 1 in manufacturing the HDD 1. For example, if the HDD 1 satisfies requirements of two specification categories, the test process is required to determine the specification category to which the HDD 1 is to belong.

The test process in the present example can control the quantity to be manufactured in each specification category using the switching function. For example, the test process determines priority of each specification category. The HDC/MPU 23 or a test computer assigns the specification category with higher priority to an HDD 1 if the HDD belongs to a plurality of specification categories. The test computer counts the quantity to be manufactured in each specification category. When the number of stock in any specification category reaches a reference value, the switching function of the HDC/MPU 23 deletes the unnecessary specification category from the selection (turns off the switch for the specification category), which achieves a desired quantity to be manufactured in each specification category.

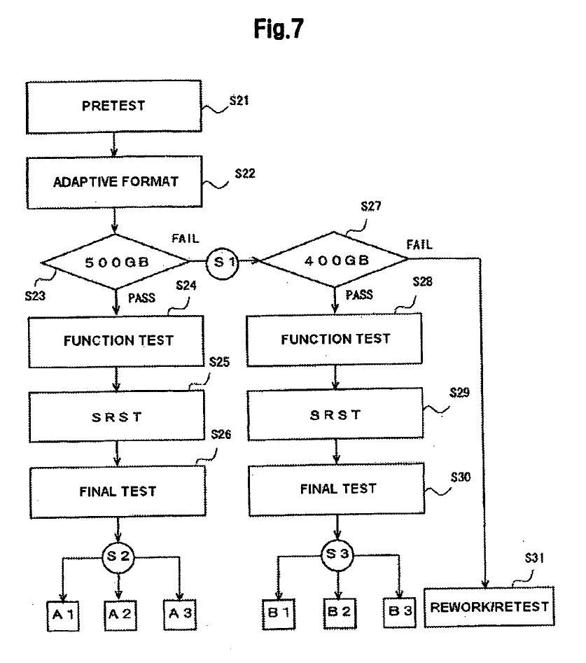

In the test process explained in reference to FIG. 3, the storage capacities of the specification categories 1 to 3 to which the HDDs 1 are classified are the same. Another preferred test process has specification categories with different storage capacities. Referring to the flowchart of FIG. 7, a test process having a step for determination of storage capacity will be described. In FIG. 7, the steps of a pretest (S21), function tests (S24, S28), SRSTs (S25, S29), and final tests (S26, S30) are the same as in the test process in FIG. 3, and descriptions thereof are omitted.

A feature of this test process is to select a specification category with a smaller storage capacity (400 GB in the present example) if the test subject HDD 1 cannot attain 500 GB of storage capacity in determination of adaptive format (S22). In this way, selecting one storage capacity from a plurality of storage capacities by the test process prevents reduction of throughputs in manufacture or reduces the number of components to be discarded even if head characteristics are not uniform.

The HDC/MPU 23 determines the TPI and the BPI in accordance with the head characteristics of each head slider 12. For example, in the case that the minimum TPI and BPI have been set in order to attain 500 GB, if the error rate is not within the reference range (FAIL in S23), the HDC/MPU 23 alters the specification category for the HDD 1 from 500 GB of storage capacity into 400 GB of storage capacity. If the HDD 1 can attain 500 GB (PASS in S23), the HDC/MPU 23 selects the specification category to which the HDD 1 is to belong from the specification categories of 500 GB, A1 to A3.

The HDC/MPU 23 performs the same process in the specification categories of 400 GB. The HDC/MPU 23 determines the TPI and BPI for each head slider 12 in accordance with the 400 GB of storage capacity and characteristics of each head slider 12. If the setting does not satisfy the criteria for the error rate (FAIL in S27), the HDD 1 is transferred to a rework process or a retest process (S31).

If the setting satisfies the criteria for the error rate (PASS in S27), the HDC/MPU 23 selects the specification category to which the HDD 1 is to belong from the specification categories of 400 GB, B1 to B3. Generally, if the storage capacity is reduced, the error rate remarkably improves. Therefore, the number of HDDs 1 to be determined to be failed products can be significantly reduced. It is the same as in the test process in FIG. 3 that the HDD 1 may be determined to be a failed product after the determination of storage capacity.

The test process in FIG. 7 comprises a switch S1 to be used in determination of capacity in addition to the switches S2 and S3 to be used in determination of specification category in the final test. The ON/OFF of the switch S1 has been set in the program to be downloaded by the HDC/MPU 23 from the test computer. The switching function S1 can be used in controlling the quantity to be manufactured of HDDs 1 like the switching functions S2 and S3. When the switch S1 is OFF, HDDs 1 which do not satisfy the capacity of 500 GB are transferred to a rework process or a retest process similarly to in the test process in FIG. 3.

As set forth above, the present invention has been described by way of particular embodiments but is not limited to the above embodiments. Embodiments of the present invention can of course be modified in various ways within the scope of the substance of the present invention. For example, in the above embodiments, an HDD has been described by way of example, but embodiments of the present invention can be applied to a disk drive device using other kinds of disks. The switching function may be applied to a test process to determine only the storage capacity of an HDD. In this case, the specification categories should be two of the 500 GB and the 400 GB. As described above, the test process may have a switching function, but a test process which does not have a switching function can improve the manufacturing efficiency of HDDs by classifying HDDs into a plurality of specification categories based on a property other than the storage capacity.

What is claimed is:

1. A test method of a disk drive device comprising:
positioning a head using servo data on a disk;
conducting tests with respect to a plurality of items by writing and/or retrieving data to/from the disk using the positioned head; and
determining a specification category to which the disk drive device with a predetermined storage capacity is to belong based on the test results on one or more items selected from the plurality of items.

2. The test method according to claim 1, wherein test results of at least a part of the test items to be used in determination of the specification category are pass or fail.

3. The test method according to claim 1, further comprising:
writing the servo data on the disk using the head; and
selecting the storage capacity from preset values in accordance with head characteristics after writing the servo data.

4. The test method according to claim 1, wherein a test item to be used in determination of the specification category measures variation in error rate on a center track caused by writing the both adjacent data tracks.

5. The test method according to claim 4, wherein a test item to be used in determination of the specification category measures variation in error rate when target positions of both adjacent data tracks are brought closer to a center data track than in a normal operation.

6. The test method according to claim 1, wherein a test item to be used in determination of the specification category measures a response time to a command from an external.

7. The test method according to claim 1, wherein the specification category subjected to the determination is selected from a plurality of specification categories in accordance with setting.

8. The test method according to claim 2, wherein the storage capacity subjected to the selection is selected from a plurality of specification categories in accordance with setting.

9. A manufacturing method of a disk drive device comprising:
positioning a head using servo data on a disk;
conducting tests on the disk drive device by writing and/or retrieving data to/from the disk using the positioned head;
selecting one or more specification categories subjected to determination from a plurality of specification categories in accordance with setting; and
determining a specification category to which the disk drive device is to belong based on the test results.

10. The manufacturing method according to claim 9, wherein the selecting one or more specification categories subjected for determination from a plurality of specification categories includes selecting a storage capacity of the disk drive device.

11. The manufacturing method according to claim 10, wherein
the test on the disk drive device includes a plurality of test items on the disk drive device of which the storage capacity has been predetermined;
the final specification category to which the disk drive device with the predetermined storage capacity is to be belong based on test results of the one or more items selected from the plurality of test items; and
the specification category to be subjected to the determination of the final specification category is selected from a plurality of specification categories in accordance with setting.
